(19) United States
(12) Patent Application Publication
(10) Pub. No.: US 2006/0076749 A1
(43) Pub. Date: Apr. 13, 2006

(54) Traction block

(76) Inventor: David Hoppert, Woodburn, OR (US)

Correspondence Address: DAVE HOPPERT, 1085 DEER RUN LANE, WOODBURN, OR, 97071, US

(21) Appl. No.: 10/960,345

(22) Filed: Oct. 7, 2004

(51) Int. Cl. B60G 11/02; B60G 7/00

(52) U.S. Cl. 280/124.17

(57) ABSTRACT

The Traction Block is a rear suspension device that directly attaches a rear spring spacer to a traction bar. The system advantageously links the traction bar device directly to a rear spacer block to create a simple product capable of limiting axle wrap and wheel hop.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF INVENTION

1. Field of Invention

This invention provides a suspension system that improves performance while eliminating disadvantageous problems that are often associated with rear spring spacers.

2. Background of the Invention

Leaf spring suspensions in vehicles have been utilized since the days of the horse drawn buggy and are still considered a standard approach to building vehicle suspensions today. Presently, leaf springs are most commonly used in the rear of Light Duty Trucks, Pickup Trucks, and Sport Utility Vehicles. As the overall quality of these vehicles has advanced, the shortcomings of leaf spring suspensions have become more apparent. The drivers of these vehicles have come to expect a smooth ride while maintaining the ability to tow heavy loads. Industry has responded to this customer demand by reducing the spring rate of the leaf springs to provide for the desired smoother ride. However, by reducing the spring rate the axle rotational control ability is reduced and the vehicles will suffer from increased axle wrap and wheel hop during acceleration and when pulling heavy loads.

Axle Wrap, also commonly called Spring Wrap, occurs when torque applied through the drivetrain to the tires focuses force on the pinion shaft in the rear drive axle. This force causes the drive axle to rotate the opposite direction from the tire rotation, ultimately forces the pinion shaft angle to increase. The rotation of the axle occurs as the leaf springs deflect the force caused by the applied torque. This reaction creates stress that damages, and eventually destroys, drivelines, yokes, drive shafts, and pinions shafts. When Axle Wrap overloads spring tension, it creates another problem: Wheel Hop.

Wheel Hop consists of inconsistent traction control and uncontrolled vertical suspension movement. Wheel Hop occurs when maximum torque is applied to the drivetrain, overcoming the rotational resistance of the leaf spring, allowing Axle Wrap. When the spring reaches its rotational limit, it reacts with a violent release of the stored energy in the spring. This violent energy release transfers thru the spring to axle, thru the axle to the wheel then to the tire where it contacts the ground. The weight of the truck and the adhesion of the tire won't allow the tire to slip, loose traction or spin free. The result is the tire sidewall deflects and then releases the energy by hopping up. When the hop occurs it reduces the weight of the truck pushing down on the tire for a split second. This hop is a violent vertical action of the tire and causes the tire to jump off the ground allowing it to spin free in the air. When the tire hits the ground again, it loads the spring with increasingly more torque and amplifies the next hop of the wheel. This action continues until the torque is reduced. The result is damage to the drivetrain, U joint failure and limited forward momentum. In sand or gravel wheel hop can make the smallest hill impassable pulling a trailer or other heavy load. Customers purchase Trucks and Suv's to take off highway while pulling trailers or hauling loads and are very dissatisfied with off road capability due to Wheel Hop.

Background Information—Prior Art:

The prevalence of axle wrap and wheel hop is affected by the installation of Rear Spring Spacers and Traction Bars. Typical examples of these inventions can be found in the following United States of America patents:

| Rear Spring Spacers: | |
|---|---|
| 4,141,428 | Loeb |
| Traction Bars: | |
| 5354092 | Calvert |
| 6273441 | Neavitt, Duquette |

The Rear Spring Spacer, also commonly referred to as a Lift Block or Axle Spacer, is a block that is placed between the rear axle and leaf springs. Vehicle manufacture use these spacers to match the rear ride height to the front as engine packages and suspension packages are changed. As the distance between the axle and the vehicle's frame gets taller, the spring spacer needs to be thicker. As the distance between axle and the spring increases, the leverage is amplified and there is an increase of Axle Wrap and Wheel Hop.

To prevent axle wrap and wheel hop, products called Traction Bars, also referred to as a Stabilizing Arm have been developed. They locate the axle housing to the frame by providing an link that acts as a brace preventing the rear axle housing from moving forward, stopping rotation (Axle Wrap) and keeping the original pinion angle controlled without stopping vertical movement. Some traction bars require advanced welding to install. Not only is this welding difficult for the average person to install, but also welding the traction bars on to the rear axle causes heat warping of the axles, requires cleaning out the residue, and changing the oil in the differential. This welding could void vehicle manufacture warranty. Although bolt on products do exist, some are mounted either to the axle or the leaf springs. Some are mounted between the axle spacer and the axle. All of these methods have their shortcomings. Never before has an axle spacer been incorporated the with the traction bar.

The past inventions have provided separate attempts to solve problems that are common and interrelated. The spacer increases axle wrap and the traction bar reduces it. My invention replaces the need to have two products with a single invention capable of directly connecting traction bars to the spring spacer. This invention does not require any welding. This invention allows full vehicle wheel travel, factory ride and handling.

Background Information—Objects and Advantages:

The present invention has been devised to resolve a continuing need for a single suspension system capable of eliminating axle wrap and wheel hop while maintaining a level vehicle drive height. The major objective accomplished by this invention is the development of a single unit that combines the advantages of a Rear Spring Spacer and a Traction Bar. This accomplishment will provide consumers with one product that previously required two unrelated products. A further objective satisfied by the present invention is the complete lack of welding necessary to install the Traction Block, this advantage will allow for simple installation. The Traction Block is an easy to install device that is the only single product consumers can choose to limit wheel hop and axle wrap while maintaining the desired horizontal ride height.

### SUMMARY OF THE INVENTION

Considered broadly, the suspension modifications according to the invention consist of a single axle spacer that provides for a direct bolt on attachment of the traction bar tube. The system advantageously links the traction bar device directly to a single axle spacer block and removes the need for axle welding or the stacking of lift blocks.

### BRIEF DESCRIPTION OF THE DRAWINGS

The preferred embodiment of the invention will be illustrated in the following figure:

FIG. 1 shows an elevation view of a vehicle rear frame, spring pack, and axle showing the invention in its position inserted between the axle, spring pack, and mounted front frame mounts.

FIG. 2 is a dissembled Traction Block with traction bar extending from the left to the spacer, which is illustrated on the right.

FIG. 3-A is a partial view closely showing the connection between spacer and traction bar.

FIG. 3-B shows the partial view in relation to the installed invention.

### DETAILED DESCRIPTION

For the purpose of this disclosure reference to portions of the vehicle drive assembly are made with respect to only one side of a rear axle assembly of the rear portion of the vehicle and it is to be understood that there is a substantially symmetrical side of the axle assembly on the opposite end thereof, which is not depicted in the drawings.

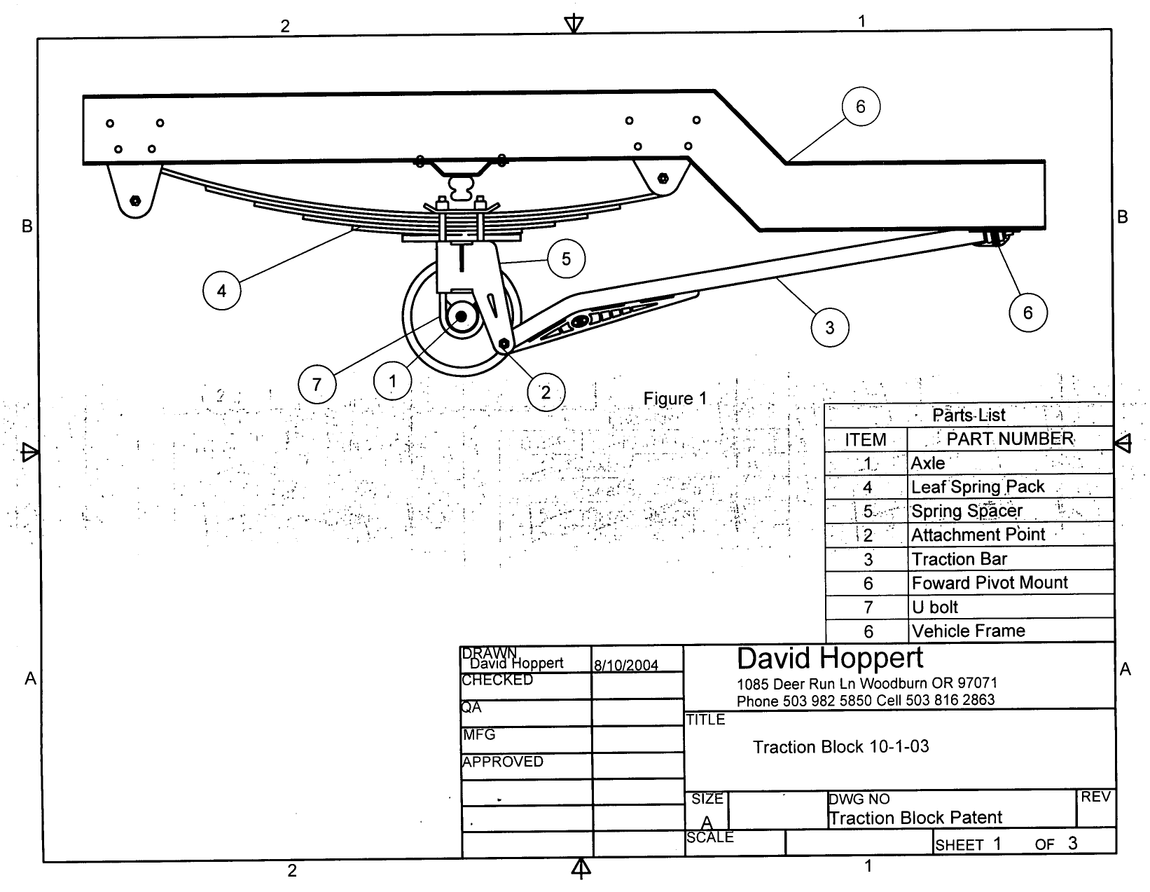

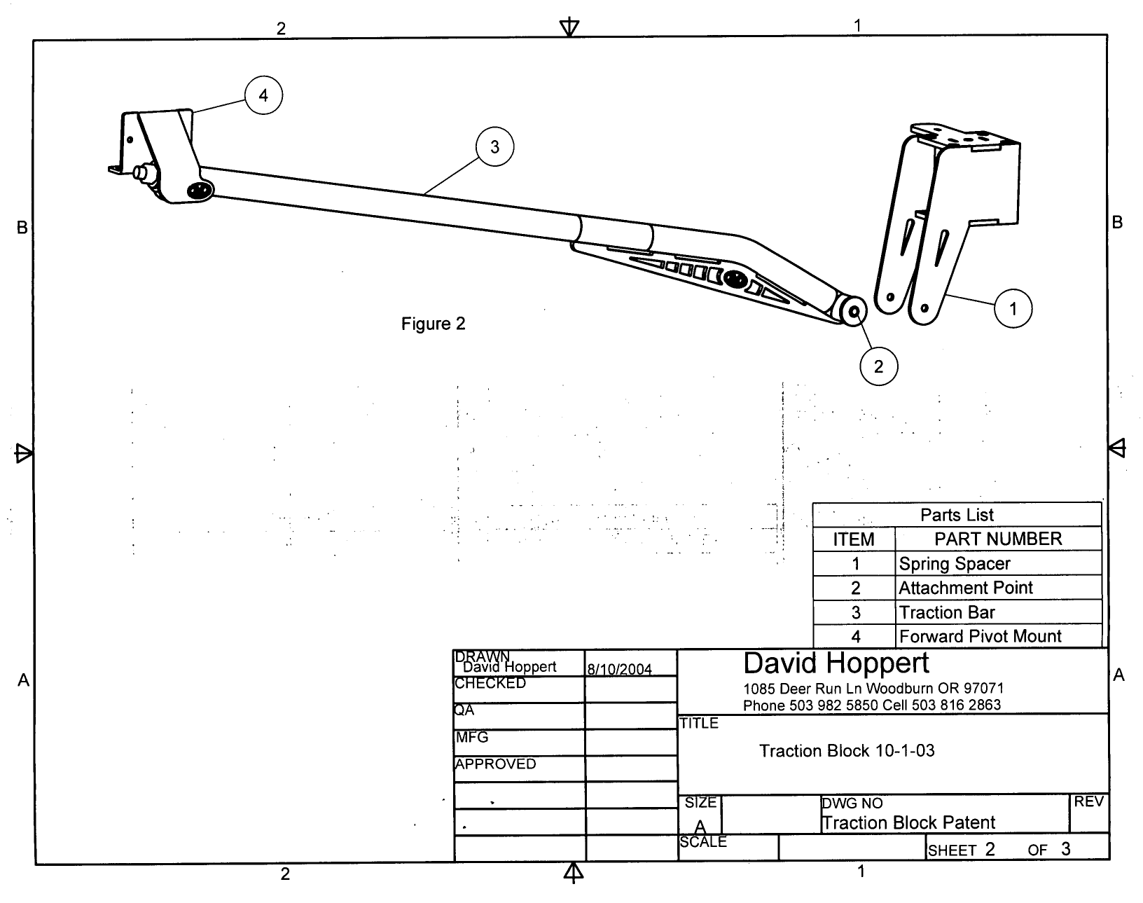

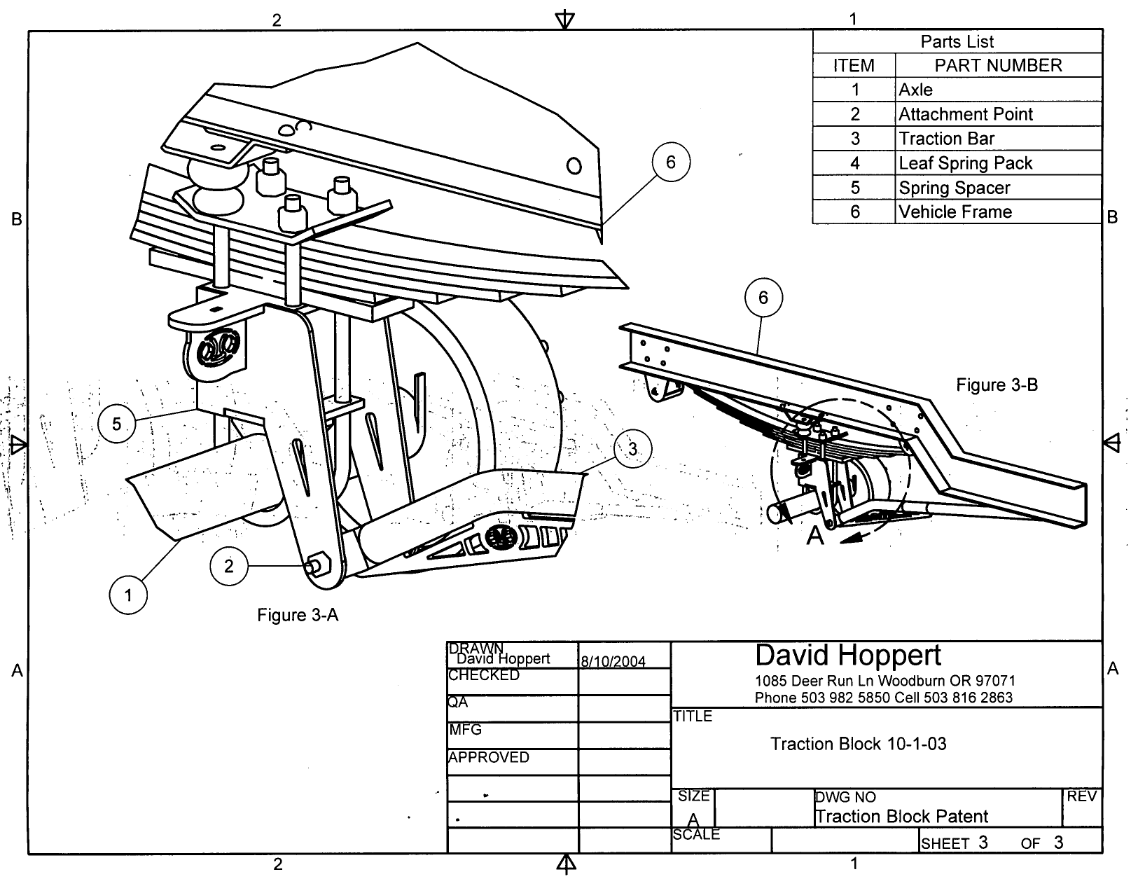

In the preferred embodiment of the invention, illustrated in FIG. 1, the axle, item 1, is separated from a leaf spring, item 2, by a single spacer, item 1 in FIG. 2, placed between the axle and set of leaf springs. The spacer was fabricated with steel, however, many alternative metals like aluminum and stainless steel can be used in place of steel. Wherein the function of said spacer is to maintain a specified ride height. Said spacer incorporates attachment points, item 2 in FIG. 2 and item 2 in FIG. 3, where a traction bar, item 3 FIG. 3, are connected via bolts. The connection between said traction bar and spring spacer is shown in detail in FIG. 3.

As a result of the present invention, it is now possible for the owner of the vehicle to install a single bolt on product that limits wheel hop and axle wrap with traction bars that connect directly to the axle spacers.

### CONCLUSIONS, RAMIFICATIONS AND SCOPE OF THE INVENTION

The reader will see that the invention of the Traction Block provides vehicle owners, for the very first time, a single product that replaces the need for purchasing a Traction Bar and Rear Axle Spacer. The Traction Block is a rear suspension device that is capable of keeping the vehicle ride height level while limiting wheel hop and axle wrap.

While my above description contains specific details, these should not be taken as limitations on the scope of the invention, but rather as an instance of one preferred embodiment of my invention. There are many variations possible that ultimately yield the same invention:
(a) to connect the spring spacer to the traction block by welding the two together.
(b) to die cast a single unit that serves as both the traction bar device and spring spacer.
(c) to create a separate device, so that this new unit allows for a connection between spacer block and traction arm device.

For this reason, the scope of my invention should be determined by the appended claims and their legal equivalents, and not the embodiment illustrated.

The embodiment of this invention in which an exclusive property or privilege is claimed are defined as follows:

1. A rear suspension device comprising: a traction bar device linked to a forward mount, a rear spring spacer that consists of a single block thicker than one inch lying between the rear axle and leaf springs, and providing means of attachment to said traction bar, whereby said rear spring spacer and said traction bar device are connected.
